(19) United States
(12) Patent Application Publication
(10) Pub. No.: US 2009/0140843 A1
(43) Pub. Date: Jun. 4, 2009

(54) METHOD FOR PROVIDING RADIO FREQUENCY IDENTIFICATION APPLICATION INTERFACE AND SYSTEM THEREOF

(75) Inventors: Hyo Chan BANG, Daejeon (KR); Jee Sook EUN, Daejeon (KR); Se Won OH, Daejeon (KR); Jae Heum LEE, Daejeon (KR); Jong-Hyun PARK, Daejeon (KR); Hyung-Jin AHN, Seoul (KR); Kwang-Hoon KIM, Yongin-si (KR)

Correspondence Address: CANTOR COLBURN, LLP, 20 Church Street, 22nd Floor, Hartford, CT, 06103, US

(73) Assignee: Electronics and Telecommunications Research Institute, Daejeon (KR)

(21) Appl. No.: 12/256,147

(22) Filed: Oct. 22, 2008

(30) Foreign Application Priority Data
Nov. 29, 2007 (KR) 10-2007-0122756

(51) Int. Cl. H04Q 5/22

(52) U.S. Cl. 340/10.51

(57) ABSTRACT

The present invention relates to an RFID application interface method and a system thereof. In the present invention, an RFID middleware system changes a control request input from a user or an RFID application system according to a communication protocol of an RFID device to be controlled, and sends it to the RFID device. Also, when the user or the RFID application system inputs a data process policy that is common to various RFID devices of a logical RFID device group, the RFID middleware system generates data process rules that are suitable for communication capability and data processing capability of each RFID device based on the data process policy and provides an interface that allows processing of data by a corresponding RFID device. In addition, the RFID middle system defines a procedural flow of at least one of services and at least one of tasks that constitute an RFID business process and provides an interface to support interconnection and cooperation of services that are included in the RFID business process.

### CROSS-REFERENCE TO RELATED APPLICATION

This application claims priority to and the benefit of Korean Patent Application No. 10-2008-0122756 filed in the Korean Intellectual Property Office on Nov. 29, 2007, the entire contents of which are incorporated herein by reference.

### BACKGROUND OF THE INVENTION

(a) Field of the Invention

The present invention relates to a method for providing an radio frequency identification (RFID) application interface and a system thereof.

The present invention is supported by the IT R&D program of MIC/IITA [2007-S-024-01, Development of SSI (Software System Infrastructure) Platform Technology for Advanced RFID services].

(b) Description of the Related Art

Existing application services for RFID are focused on directly controlling an RFID tag or a reader, and processing and storing data collected from corresponding devices.

Also, in the related art, since RFID application services have been developed, depending on an individual interface that is provided by a special device development vender, there is a problem that it is difficult to construct an application service environment to manage devices of various types by a unified method.

In order to solve the problem, methods for providing unified management to devices of different types by the fact that an RFID middleware system is positioned between an application service and an RFID device to perform control like the vender have been provided. However, the RFID middleware system only processes individually data and controls RFID devices based on a data type provided by each RFID device and a control interface as an agent. As a result, there is a limit to integratedly manage the total RFID devices and to process data. In addition, an RFID application service is realized depending on an interface of a middleware development company, and thereby it is also difficult to interconnect RFID application services using different middleware.

As above-described, there is a problem in that the existing RFID application services being dependent on a special RFID device, RFID data, or an RFID middleware system do not provide user centered services and are individually organized according to an aim of a business.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and a system that provide interfaces for synthetically managing various RFID devices and RFID data, and to provide RFID application interfaces for interconnecting between various RFID services and for synthetically managing them.

An exemplary embodiment of the present invention provides a method for providing an RFID application interface to an RFID device group including at least one RFID device. The method includes being provided with a data process policy corresponding to the RFID device group, changing the data process policy into data process rules corresponding to each RFID device based on data processing capability of each RFID device, determining whether it is possible to apply a data process rule to the corresponding RFID device based on the data processing capability and communication capability of the corresponding RFID device, and sending the data process rule to the corresponding RFID device when it is determined that it is possible to apply it.

Another exemplary embodiment of the present invention provides a system for providing an RFID application interface to an RFID device group including at least one RFID device. The system includes a service control interface module for generating data process rules based on data processing capability of each RFID device included in the RFID device group by analyzing a data process policy corresponding to the RFID device group when the data process policy is input, and a context management module for determining whether it is possible to apply a data process rule to a corresponding RFID device based on the data processing capability and communication capability of the corresponding RFID device, and sending the data process rule to the corresponding RFID device when it is determined that it is possible to apply it.

Still another exemplary embodiment of the present invention provides a system for providing an RFID application interface to an RFID device group including at least one RFID device. The system includes a device integration management interface unit for analyzing a data process policy based on data processing capability of each RFID device included in the RFID device group and generating data process rules corresponding to each RFID device, and a task integration interface unit for scheduling a business process that includes at least one service and at least one task related to the RFID device group according to a predetermined procedural flow and supporting interconnection between services that have different service domains.

A further exemplary embodiment of the present invention provides a system for providing an RFID application interface to an RFID device group including at least one RFID device. The system includes an integration interface unit for changing a device control request into device control rules corresponding to each RFID device included in the RFID device group based on a communication protocol of each RFID device and generating data process rules corresponding to each RFID device by analyzing a data process policy based on data processing capability, a data management unit for performing a data process using a determined data process rule that it is not applied to the corresponding RFID device based on the data processing capability and communication capability of the corresponding RFID device among the data process rules, and a device interface unit for sending a determined data process rule that it is not applied to the corresponding RFID device based on the data processing capability and communication capability of the corresponding RFID device among the data process rules and the device control rule to the corresponding RFID device according to a communication protocol.

### BRIEF DESCRIPTION OF THE DRAWINGS

FIG. 1 shows a configuration diagram of a system for an RFID application interface according to an exemplary embodiment of the present invention.

FIG. 2 shows a configuration diagram of a device integration management interface unit according to the exemplary embodiment of the present invention.

FIG. 3 shows a configuration diagram of a task integration interface unit according to the exemplary embodiment of the present invention.

FIG. 4 shows configuration diagram of a task management module according to the exemplary embodiment of the present invention.

FIG. 5 shows an example for a task management module to schedule a service and a task mapped with event data.

FIG. 6 shows a flowchart of a method for the RFID middleware system to provide an integration management interface to various RFID devices of different types according to the exemplary embodiment of the present invention.

FIG. 7 shows an example for the RFID middleware system to provide the integration management interface according to the exemplary embodiment of the present invention.

FIG. 8 shows a flowchart of a method for the RFID middleware system to provide an interface to process data of a logical RFID device group according to the exemplary embodiment of the present invention.

FIG. 9 shows an example for the RFID middleware system to provide the interface to process data of the logical RFID device group according to the exemplary embodiment of the present invention.

FIG. 10 shows a flowchart of a method for the RFID middleware to generate a process model corresponding to a specific business process according to the exemplary embodiment of the present invention.

FIG. 11 shows a flowchart of a method for the RFID middleware system to schedule a task according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, in addition, unless explicitly described to the contrary, the word “comprise” and variations such as “comprises” or “comprising” will be understood to imply the inclusion of stated elements but not the exclusion of any other elements.

In addition, the terms “-er”, “-or”, and “module” described in the specification mean units for processing at least one function and operation, and can be implemented by hardware components or software components and combinations thereof.

Now, an RFID application interface method and a system thereof according to an exemplary embodiment of the present invention will be described in detail.

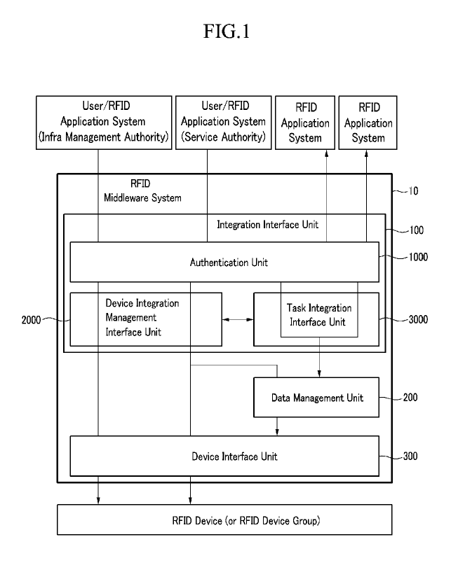

FIG. 1 shows a configuration diagram of an RFID middleware system 10 for an RFID application interface according to an exemplary embodiment of the present invention.

Referring to FIG. 1, the RFID middleware system 10 includes an integration interface unit 100, a data management unit 200, and a device interface unit 300.

The integration interface unit includes an authentication unit 1000, a device integration management interface unit 2000, and a task integration interface unit 3000.

The authentication unit 1000 performs user authentication and a permission process to all control requests and service requests from a user or an RFID application system, and provides an access control interface function by each service unit to external users.

The device integration management interface unit 2000 performs an interface function that changes a device control request into a device control rule that is suitable for an RFID device to be controlled and sends it to the RFID device when a user or an RFID application system having management authority for RFID infrastructure inputs the device control request for various RFID devices of different types in the same manner. In addition, when a user or an RFID application system having RFID service authority inputs a data process policy for a logical RFID device group that has at least one RFID device, the device integration management interface unit 2000 generates a data process rule that is suitable for the data processing capability of each RFID device based on the data process policy. The device integration management interface unit 2000 provides an integrated interface between a user or an RFID application system and an RFID device so that the user or the RFID application system may request the device control or a data process using a predetermined interface method without considering a type and a protocol of an RFID device to be controlled.

The task integration interface unit 3000 provides an interface for supporting procedure performance, cooperation, and interconnection between at least one of tasks and at least one of RFID services. Here the tasks and the RFID services constitute an RFID business process related to an RFID device.

The data management unit 200 performs a data process for a corresponding RFID device using the data process rule from the device integration management interface unit 2000.

The device interface unit 300 performs an interface between the RFID middleware system 10 and an RFID device, and sends the device control rule and the data process rule from the integration interface unit 100 according to a corresponding communication protocol to a corresponding RFID device.

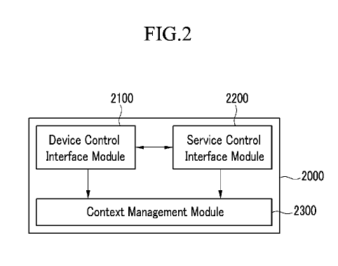

FIG. 2 shows a configuration diagram of the device integration management interface unit 2000 according to the exemplary embodiment of the present invention.

Referring to FIG. 2, the device integration management interface unit 2000 includes a device control interface module 2100, a service control interface module 2200, and a context management module 2300.

The device control interface module 2100 changes an RFID device control request that is input from a user or an RFID application system having management authority for RFID infrastructure into a device control rule that is suitable for an RFID device based on a communication protocol of the RFID device to be controlled. In this case, when an object to be controlled is a logical RFID device group including various RFID devices of different types, the device control interface module 2100 changes the RFID device control request into device control rules that are suitable for each RFID device of the group.

The service control interface module 220 analyzes the data process policy such as a tag data collecting rule, a filtering rule, a reporting rule, and a tag memory reading/writing rule that are defined by a user or an RFID application system for the logical RFID device group including at least one of RFID devices, and generates a data process rule that is suitable for each corresponding RFID device with regard to the data processing capability of each RFID device. Here, the data processing capability of the RFID device represents a reader protocol (RP), a low level reader protocol (LLRP), an application level event (ALE), and others.

The context management module 2300 performs a validation check to a device control rule through grammar verification and meaning interpretation when the device control rule is input from the device control interface module 2100. Also, the context management module 2300 determines whether collision between a new device control rule and an old device control rule applied to an RFID device to be controlled exists. The verified device control rule as above-described is sent to a corresponding RFID device according to a corresponding communication protocol by the device interface unit 300.

Further, the context management module 2300 performs a validation check to a data process rule through grammar verification and meaning interpretation when the data process rule is input from the service control interface module 2200. Also, the context management module 2300 determines whether collision between a new data process rule and an old data process rule applied to a corresponding RFID device to be controlled exists. The context management module 2300 determines communication capability and data processing capability of the corresponding RFID device. When the data process rule may be directly applied to the RFID device, the context management module 2300 sends the data process rule to the RFID device. However, when the data process rule may be not directly applied to the RFID device, the context management module 2300 sends the data process rule to the data management unit 200. Here, the device interface unit 300 sends the data process rule from the data management unit 200 to the RFID device after processing the data process rule according to a communication protocol corresponding to the RFID device.

Meanwhile, when the context management module 2300 sends the data process rule to the corresponding RFID device, the corresponding RFID device performs a data process using the data process rule. However, when the context management module 2300 sends the data process rule to the data management unit 200, the data management unit 200 rather than the RFID device performs the data process using the data process rule. For example, since it is impossible to directly apply a data process rule corresponding to an ALE rule and a report rule to a dummy reader, the data process rule is sent to the data management unit 200 so that the data management unit 200 performs the data process rule instead of the dummy reader. Meanwhile, when performing the data process rule, the data management unit 200 processes data of a corresponding RFID device using the data process rule and informs a report manager in the service control interface module 2200 of the processed result.

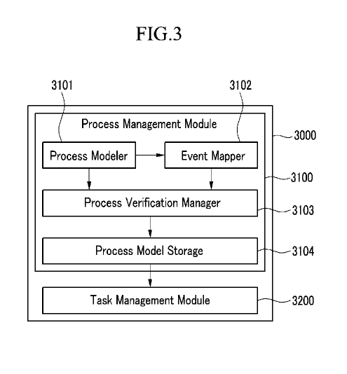

FIG. 3 shows a configuration diagram of the task integration interface unit 3000 according to the exemplary embodiment of the present invention.

Here, a task is a logical unit representing a unit task and includes a sequence of an application, wherein the application is at least one. In addition, a service includes successive procedures including at least one of tasks and is definition information that represents a service domain such as physical distribution, circulation, and manufacture. Further, a business process includes at least one of services and tasks, and represents a process that defines the services and the tasks as a successive procedure flow. In case, the business process may include services that are included in different service domains.

Referring to FIG. 3, the task integration interface unit 3000 includes a process management module 3100 and a task management module unit 3200.

The process management module 3100 includes a process modeler 3101, an event mapper 3102, a process verification manager 3103, and a process model storage 3104, and produces at least one of business processes including various RFID services and manages them.

The process modeler 3101 defines a business process based on services for constituting the business process and procedural flow of tasks that constitute the services input from a user or an RFID application system having definition authority for an RFID business process related to an RFID device. Also, the process modeler 3101 defines detail information on tasks that are units of constituting a corresponding business process, and connects a defined task with a business process based on inputted procedural flow. Here, detail information by task includes a task name, information on an application that is used in executing the task, sequence of applications that constitute the task, input/output parameters that are needed in each application, and others.

The event mapper 3102 defines a connection relation between a task that constitutes a business process and an RFID event that is obtained from an RFID device or the RFID middleware system 10, that is, a connection between the task and event data related to an RFID tag.

The process verification manager 3103 verifies efficiency of the business process defined by the event mapper 3102 and the process modeler 3101.

The process model storage 3104 performs a function for storing a business process that is determined to be efficient through verification of the process verification manager 3103.

The business process that is verified and then stored in the process model storage 3104 will be called “a process module”.

The task management module 3200 processes procedural or parallel flow of tasks and services that constitute a specific RFID business process, and performs a function for managing interconnection between a service and a task that are different from each other.

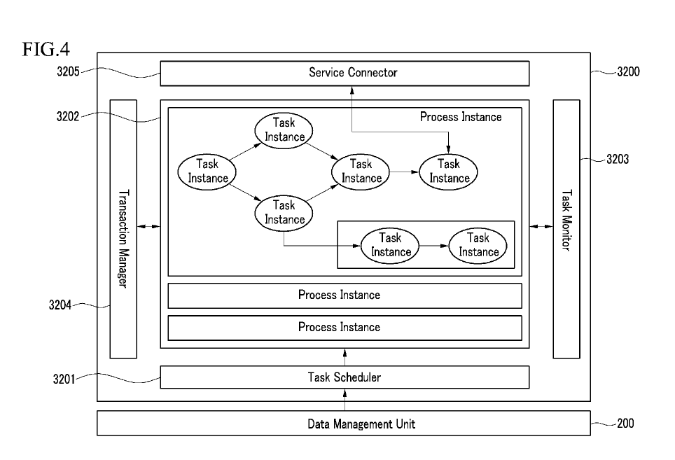

FIG. 4 shows a configuration diagram of the task management module 3200 according to the exemplary embodiment of the present invention.

Referring to FIG. 4, the task management module 3200 includes a task scheduler 3201, a process instance storage 3202, a transaction manager 3204, a task monitor 3203, and a service connector 3205.

The task scheduler 3201 reads information on a process model corresponding to a business process to be executed from the process management module 3100. Further, the task scheduler 3201 executes the RFID business process by sequentially instantiating services and tasks that are included in the read process model based on a predetermined procedural flow. As a result, a corresponding RFID business process instance performs scheduling so that the services and the tasks included in the instance are processed on the basis of the predetermined procedural flow.

Meanwhile, the task scheduler 3201 manages the task that is mapped with event data related to an RFID tag among the tasks included in the business process to be instantiated in a waiting condition until the mapped event data is generated. Then, when the generation of the mapped event data is detected, the task scheduler 3201 executes a corresponding task by instantiating it. In this case, when the execution of the instantiated task is completed according to the detection of the mapping event data, the execution result is sent to a following task.

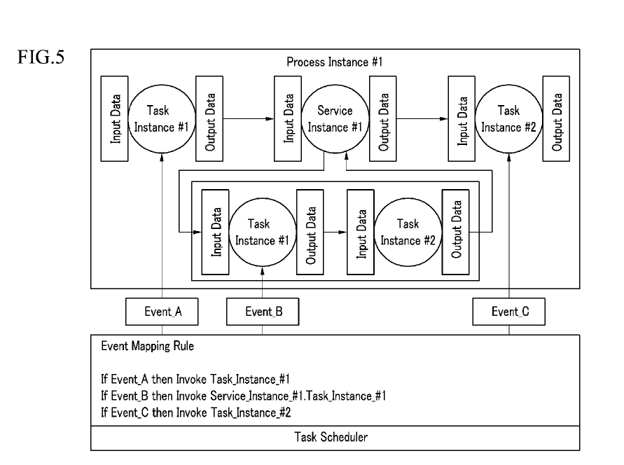

FIG. 5 shows an example for the task management module 3200 to schedule a task mapped with event data. Referring to FIG. 5, event data received in a specific task may be used as input data for task transition or output data to be sent to a following task.

In FIG. 4, the task scheduler 3201 also performs a function for storing a corresponding task in the process instance storage 3202 whenever the state of the task that is instantiated and is then being executed or the state of the task of which execution is completed is changed.

The task monitor 3203 performs an analysis of a current state or an analysis of a prior state to all of instances that are managed by the task monitor 3203, that is, a process instance, a service instance, and a task instance, and informs a manager of the analysis result.

The transaction manager 3204 manages a transaction related to a service instance and a task instance that are included in a process instance corresponding to a specific business process. That is, the transaction manager 3204 manages transaction of process instances by performing protection of a logical transaction from a point at which the operation of each tack or service is started to a point at which the operation is completed, and informs the task scheduler 3201 of information on the protection.

When an interconnection between a task that is being executed in a process instance and a service that corresponds to a different service domain is needed, the service connector 3205 supports the interconnection for processing operations between the task and the service. Referring to FIG. 5, a task instance #1 has a need for an interconnection with a service instance #1 that corresponds to a different service domain, and in this case, the task instance #1 is interconnected with the service instance #1 through the service connecter 3205.

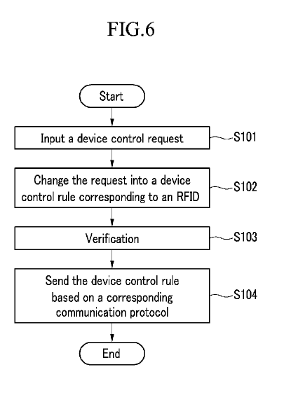

FIG. 6 shows a flowchart of a method for the RFID middleware system 10 to provide an integration management interface for various RFID devices of different types according to the exemplary embodiment of the present invention.

Referring to FIG. 6, the device integration management interface unit 2000 generates a device control rule by converting a device control request based on a communication protocol of an RFID device to be controlled when the device control request is input from a system having authority for managing RFID infrastructure (S102). Also, the device integration management interface unit 2000 performs a validation check to the generated device control rule (S103).

The device control rule is sent to the device interface unit 300 after the validation check, and the device interface unit 300 sends it to the RFID device to be controlled according to the corresponding communication protocol (S104).

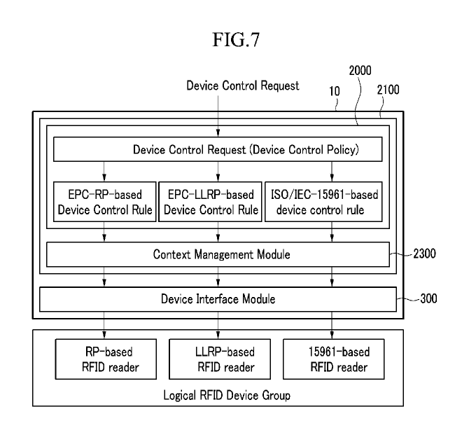

FIG. 7 shows an example for the RFID middleware system 10 to provide an integration management interface according to the exemplary embodiment of the present invention. More specifically, FIG. 7 shows an example for sending a control request of a user or an RFID application system to a logical RFID device group that includes at least one of RFID devices of different types.

In FIG. 7, when a control request for a logical RFID device group including an RP-based RFID reader, an LLRP-based RFID reader, and a 15961-based RFID reader is input, the device control interface module 2100 changes the control request into device control rules corresponding to each RFID reader of the group based on a communication protocol that corresponds to each of the RFID readers.

That is, the control request is changed into a device control rule based on EPC-RP according to a communication protocol of the RP-based RFID reader. Also the control request is changed into a device control rule based on EPC-LLRP according to a communication protocol of the LLRP-based RFID reader. Further the control request is changed into a control device rule based on ISO/IEC-15961 according to a communication protocol of the 15961-based RFID reader. These device control rules are received with a validation check by the context management module 2300 and are sent to each of the corresponding RFID readers according to a corresponding communication protocol when the validation check is completed. For example, the EPC-RP-based device control rule is sent to the RP-based RFID reader through a communication protocol process corresponding to the RP-based RFID reader.

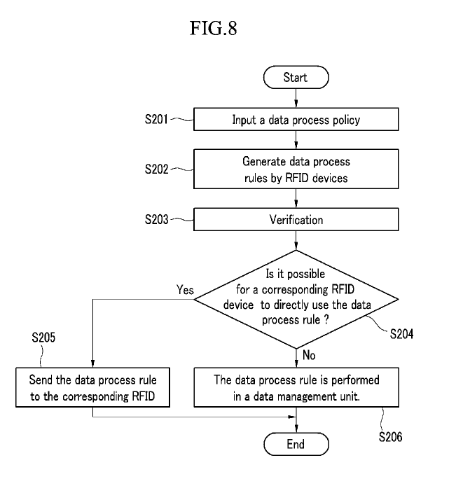

FIG. 8 shows a flowchart of a method for the RFID middleware system 10 to provide an interface to process data of a logical RFID device group according to the exemplary embodiment of the present invention.

Referring to FIG. 8, the device integration management interface unit 2000 generates a data process rule corresponding to each RFID device based on data processing capability of each RFID device when a data process policy of a logical RFID device group that includes at least one of RFID devices is input by a user or an RFID application system that has RFID service authority (S201-S202). In this case, the data process policy includes a tag data collecting rule, a filtering rule, a reporting rule, a tag memory reading/writing rule, and others for a data process of the corresponding logical RFID device group.

Then, the device integration management interface unit 2000 performs a validation check to the generated data process rules (S203). In addition, the device integration management interface unit 2000 determines whether it is possible to send each data process rule to a corresponding RFID device by determining communication capability and data processing capability of the RFID device (S204). Then, the device integration management interface unit 2000 sends the corresponding data process rule to the corresponding RFID device (S205) so that the RFID device processes data using the data process rule when it is determined that the corresponding data process rule is directly applied to the corresponding RFID device. However, when it is determined that the corresponding data process rule is not directly applied to the corresponding RFID device, the device integration management interface unit 2000 sends the data process rule to the data processing unit 300 so that the data processing unit 300 performs a data process of the RFID device (S206).

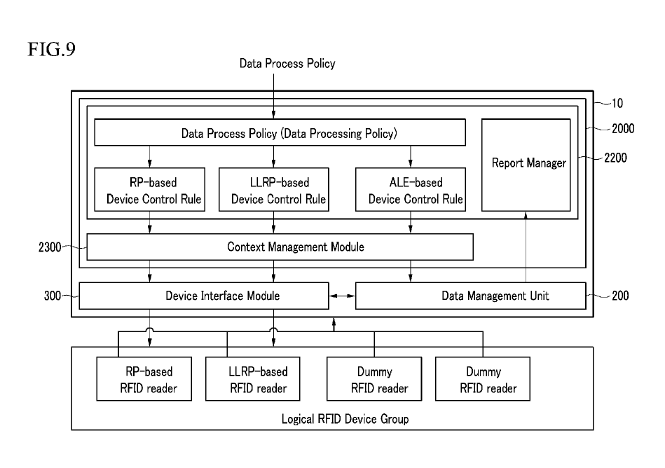

FIG. 9 shows an example for the RFID middleware system 10 to provide an interface to process data of a logical RFID device group according to the exemplary embodiment of the present invention.

In FIG. 9, when a data process policy for a logical RFID device group including an RP-based RFID reader, an LLRP-based RFID reader, and a dummy RFID reader is input, the service control interface module 2200 generates data process rules based on data processing capability of each RFID reader. That is, an RP-based data process rule corresponding to the RP-based RFID reader is generated, an LLRP-based data process rule corresponding to the LLRP-based RFID reader is generated, and an ALE-based data process rule corresponding to the dummy RFID reader is generated. When each data process rule corresponding to each RFID reader is generated, the context management module 2300 confirms communication capability and data processing capability of each RFID reader and sends a corresponding data process rule to an RFID reader, that is, an RFID device to which the corresponding data process rule can be directly applied. However, when the corresponding data process rule (ALE-based data process rule) is not directly applied to an RFID device like the dummy RFID reader, the context management module 2300 sends the corresponding data process rule to the data management unit 200. Then, the corresponding data process rule, that is, the ALE-based data process rule for the dummy RFID reader, is performed in the data management unit 200.

The data management unit 200 processes data on the dummy RFID reader using the ALE-based data processing rule and informs a report manager of the service control interface module 2200 of the processed result.

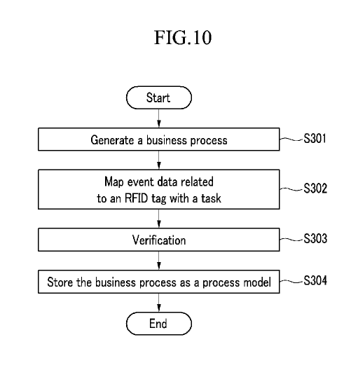

FIG. 10 shows a flowchart of a method for the RFID middleware system 10 to generate a process model corresponding to a specific business process according to the exemplary embodiment of the present invention.

Referring to FIG. 10, when a user or an RFID application system that has authority for defining a business process inputs services for constituting a business process and procedural flow of tasks that constitute the services, the task integration interface unit 3000 generates the business process based on the services and the tasks (S301). In this case, detail information on the tasks that are a basic unit for constituting the corresponding business process is also determined.

Meanwhile, a task related to event data related to an RFID tag among tasks included in the generated business process is mapped with the corresponding event data (S302).

Next, the task integration interface unit 3000 determines efficiency of the generated business process by performing a validation check (S303). Then, the task integration interface unit 3000 stores the business process that is determined to be efficient in the process model storage 3104 (S304).

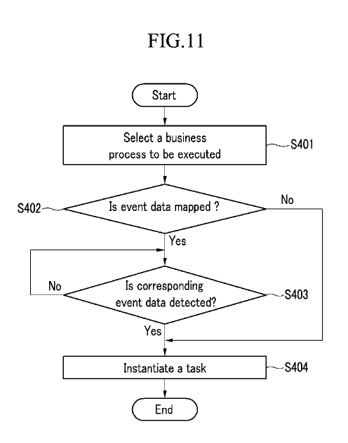

FIG. 11 shows a flowchart of a method for the RFID middleware system 10 to schedule a task according to the exemplary embodiment of the present invention.

Referring to FIG. 11, when a user or an RFID application system selects a business process to be performed in the RFID middleware system 10 (S401), the RFID middleware system 10 sequentially instantiates services and tasks of the business process based on a predetermined procedural flow.

First, the task integration interface unit 3000 determines whether each service or task is mapped with event data that is related to an RFID tag (S402). The task integration interface unit 3000 waits until event data is detected, and instantiates a service or a task mapped with the event data when the event data is detected (S403-S404). However, the task integration interface unit 3000 sequentially instantiates a task that is not mapped with event data based on the predetermined procedural flow (S405).

According to the embodiments of the present invention, the RFID middleware system changes a control request from a user to be suitable for an RFID device to be controlled and sends it to the RFID device. Therefore, it is possible that the user can control RFID devices in unification without depending on interfaces provided the RFID devices of different types.

In addition, data process rules that are suitable for each RFID device are generated based on a data process policy, and data on each RFID device is processed based on the data process rules. As a result, it is possible for a user to process RFID data in the same method that is not dependent on the type of each RFID device.

Further, interoperating and interconnection between services that correspond to different service domains are supported. Thus, there is an advantage of easily expending an RFID industry application domain. This allows a user to further conveniently use an RFID application service, and the development and distribution of the RFID application service can be flexibly performed.

The above-mentioned exemplary embodiments of the present invention are not embodied only by a method and apparatus. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.
While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for providing an RFID application interface to an RFID device group including at least one RFID device, the method comprising:
being provided with a data process policy corresponding to the RFID device group;
changing the data process policy into data process rules corresponding to each RFID device based on data processing capability of each RFID device;
determining whether it is possible to apply a data process rule to the corresponding RFID device based on the data processing capability and communication capability of the corresponding RFID device; and
sending the data process rule to the corresponding RFID device when it is determined that it is possible to apply it.

2. The method of claim 1, further comprising
performing a data process corresponding to the RFID device using the data process rule when it is determined that the data process rule is not applied to the RFID device.

3. The method of claim 1, wherein the data process rule that is sent to the RFID device is applied to a data process of the RFID device.

4. A system for providing an RFID application interface to an RFID device group including at least one RFID device, the system comprising:
a service control interface module for generating data process rules based on data processing capability of each RFID device included in the RFID device group by analyzing a data process policy corresponding to the RFID device group when the data process policy is input; and
a context management module for determining whether it is possible to apply a data process rule to a corresponding RFID device based on the data processing capability and communication capability of the corresponding RFID device, and sending the data process rule to the corresponding RFID device when it is determined that it is possible to apply it.

5. The system of claim 4, further comprising
a data management unit for processing data of the corresponding RFID device based on the data process rule,
wherein the context management module sends the data process rule to the data management unit when it is determined that it is not possible to apply it.

6. The system of claim 4, further comprising
a device control interface module for changing a device control request into data process rules corresponding to each RFID device based on corresponding communication protocol and sending the data process rules to each corresponding RFID device.

7. A system for providing an RFID application interface to an RFID device group including at least one RFID device, the system comprising:
a device integration management interface unit for analyzing a data process policy based on data processing capability of each RFID device included in the RFID device group and generating data process rules corresponding to each RFID device; and
a task integration interface unit for scheduling a business process that includes at least one service and at least one task related to the RFID device group according to a predetermined procedural flow and supporting interconnection between services that have a different service domain.

8. The system of claim 7, further comprising
An authentication unit for performing a user authentication to the data process policy and sending the data process policy to the device integration management interface unit.

9. The system of claim 7, wherein the device integration management interface module includes a device control interface module that changes a device control request into control rules corresponding to each RFID device based on a corresponding communication protocol and sends them to each RFID device.

10. The system of claim 7, wherein the device integration management interface module includes a context management module for determining whether it is possible to apply a data process rule to a corresponding RFID device based on data processing capability of the corresponding RFID device and sending the data process rule to the corresponding RFID device when it is determined that it is possible to apply it.

11. The system of claim 10, further comprising
a data management unit for being provided with the data process rule that is determined to not be applied to the corresponding RFID device and applying the data process rule to a data process for the corresponding RFID device.

12. The system of claim 7, wherein the task integration interface unit includes:
a process management module for defining the business process by procedural flow and mapping at least one task with event data; and
a task management module for instantiating the at least one service and the at least one task based on the procedural flow and the event data to execute the business process and supporting interconnection between services that correspond to a different service domain.

13. A system for providing an RFID application interface to an RFID device group including at least one RFID device, the system comprising:
an integration interface unit for changing a device control request into device control rules corresponding to each RFID device included in the RFID device group based on a communication protocol of each RFID device and generating data process rules corresponding to each RFID device by analyzing a data process policy based on data processing capability;
a data management unit for performing a data process using a data process rule that is determined to not be applied to the corresponding RFID device based on data processing capability and communication capability of the corresponding RFID device among the data process rules; and
a device interface unit for sending a data process rule that is determined to not be applied to the corresponding RFID device based on data processing capability and communication capability of the corresponding RFID device among the data process rules and the device control rule to the corresponding RFID device according to a communication protocol.

14. The system of claim 13, wherein the integration interface unit includes
a context module for determining whether it is possible to apply the data process rule to the corresponding RFID device based on the data processing capability and the communication capability of the corresponding RFID device.

15. The system of claim 13, wherein the integration interface unit further includes
a task integration interface unit for scheduling the business process that includes at least one service and at least one task related to the RFID device according to a predetermined procedural flow and supporting interconnection between services that correspond to a different service domain.
